(19) United States
(12) Patent Application Publication
(10) Pub. No.: US 2011/0002134 A1
(43) Pub. Date: Jan. 6, 2011

(54) Lamp set for bicycle

(76) Inventors: Yung-Hung CHIH, Taipei County (TW); Hsin-Cheng KUO, Taipei County (TW)

Correspondence Address: BACON & THOMAS, PLLC, 625 SLATERS LANE, FOURTH FLOOR, ALEXANDRIA, VA, 22314-1176, US

(21) Appl. No.: 12/458,135

(22) Filed: Jul. 1, 2009

(51) Int. Cl. F21V 33/00

(52) U.S. Cl. 362/473

(57) ABSTRACT

A lamp set for a bicycle comprises a lamp base, a connector, and an annular fastener, wherein the lamp base includes a housing, and the connector can engage the housing; the fastener is mounted around a bicycle frame and disposed with a connecting part for connecting to the connector; characterized in that the housing is disposed with an engaging part in its lower part, and the engaging part includes a first indentation and a second indentation which are mutually communicated, wherein the length of the second indentation is longer than the first indentation, and the connector is disposed with two engaging members having a spacing between the engaging members, and the engaging members are disposed with an engaging block respectively that the engaging blocks are capable of being squeezed by the first indentation to compress the spacing between the two engaging members while the engaging members enter the first indentation, and the spacing between the engaging members is recovered after the engaging members passed through the first indentation to engage and locate the engaging blocks in the second indentation; when the spacing between the engaging members is compressed and shorter than the length of the first indentation because of the squeezing of engaging members, the engaging blocks depart from the second indentation and the first indentation sequentially to allow the lamp base to detach from the connector.

### FIELD OF THE INVENTION

The present invention relates to a lamp set for a bicycle, particularly, to a lamp set with easy assembly and securely combination via the structure design between the lamp base, the connector, and the fastener.

### DESCRIPTION OF THE PRIOR ART

As international oil price rises, bicycles with properties of protecting environment, saving energy, and reducing carbon emissions suddenly become the most popular commodities. Moreover, nature and rural environments become a new mode of modern lifestyle and help to increase the quality of people living. Cycling is the sport with a lowest rate of incidents and help to strengthen people's physique simultaneously. People will not feel tired and exhausted but feel free and relaxed by taking different roads, thereby cycling is a new trend of modern people.

When riding a bicycle, whether commuting to work, sports or leisure purposes, bicycle safety is still the most important consideration, so various accessories for bicycle are manufactured. For example, many bicycles are usually equipped with lamps by people for assuring the safety for themselves and others while providing warning illumination at daytime or night.

However, the present design of bicycle lamp mainly utilizes an engaging base to combine the lamp and the fastener, and the lamp is designed to be removed from the fastener easily by users at any time; although the engagement method mentioned above can mount the lamp onto the bicycle frame, but the combination between the lamp, the engaging base, and the fastener is not very stable that the lamp cannot retain a fixed illuminating angle and easy to deflect during riding, even the connection is via a screw; meanwhile, the lamp may also get loose or be took down by someone else from the engaging base.

In order to overcome the foregoing shortcomings and problems, after hard research and development, a lamp set for a bicycle that substantially departs from the conventional concepts and designs of the prior art is provided by the present invention.

### SUMMARY OF THE INVENTION

The primary object of the present invention is to provide a lamp set for a bicycle with simple structure and easy assembly to allow a lamp base to securely connect to a fastener.

In order to achieve the aforementioned object, the lamp set for a bicycle according to the present invention comprises a lamp base, a connector, and an annular fastener, wherein the lamp base includes a housing, and the connector can engage the housing; the fastener is mounted on a bicycle frame and disposed with a connecting part for connecting to the connector; the lamp set is characterized in that: the housing is disposed with an engaging part in its lower part, and the engaging part includes a first indentation and a second indentation which are mutually communicated, wherein the length of the second indentation is longer than the first indentation, and the connector is disposed with two engaging members extending outwardly in the same direction from the connector, wherein a spacing is formed between the engaging members and the engaging members are disposed with an engaging block respectively that the engaging blocks are capable of being squeezed by the first indentation to compress the spacing between the two engaging members while the engaging members enter the first indentation, and the spacing between the engaging members is recovered after the engaging members passed through the first indentation to engage and locate the engaging blocks in the second indentation; when the spacing between the engaging members is compressed and shorter than the length of the first indentation because of the squeezing of engaging members, the engaging blocks depart from the second indentation and the first indentation sequentially to allow the lamp base to detach from the engagement by the connector.

In practice, the ends of the engaging members are disposed with pressing parts for being pressed and squeezed by users to narrow the spacing between the engaging members.

In practice, the engaging portion is disposed with two slants near the first indentation.

In practice, both sides of the lower part of the housing is disposed with a sliding socket respectively, and both sides of the upper part of the connector corresponding to the sliding socket is disposed with a wing portion respectively to allow the connector to move in the lower part of the connector while the wing portions enter the sliding sockets.

In practice, the lower part of the connector is disposed with a projection for removably connecting to the connecting part of the fastener, and the connecting part is disposed with an indentation forming a tapered passage inwardly, and the end of the tapered passage distends to form a locating space for the projection to enter along the tapered passage and locate in the locating space.

In practice, the engaging portion is concaved inwardly at the lower part of the housing.

Other objects, advantages and novel features of the present invention will become more apparent from the following detailed description when taken in conjunction with the accompanying drawings.

### BRIEF DESCRIPTION OF THE DRAWINGS

FIG. 1 is a perspective view of a lamp set for a bicycle of an embodiment according to the present invention.

FIG. 2 is a perspective view showing the fastener of an embodiment according to the present invention.

FIG. 3A is a perspective view showing the state before engaging the connector with the housing of an embodiment according to the present invention.

FIG. 3B is a perspective view showing the state before the engaging blocks of the engaging members entering the first indentation of an embodiment according to the present invention.

FIG. 3C is a sectional view showing the state after the engaging blocks of the engaging members entering the first indentation of an embodiment according to the present invention.

FIG. 3D is a perspective view showing the state after the engaging blocks of the engaging members entering the second indentation of an embodiment according to the present invention.

FIG. 4 is a perspective view showing the housing detaching from the connector of an embodiment according to the present invention.

FIG. 5 is a perspective view of the connector combined with the fastener of an embodiment according to the present invention.

FIG. 6 is a partially and sectional view of the connector combined with the fastener of an embodiment according to the present invention.

FIG. 7 is a perspective view of an assembled lamp set for a bicycle of an embodiment according to the present invention.

### DETAILED DESCRIPTION

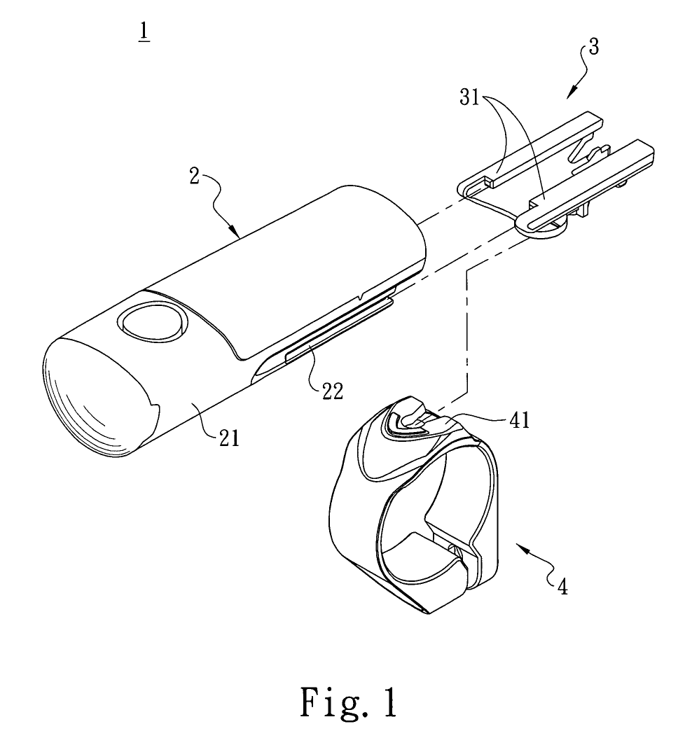

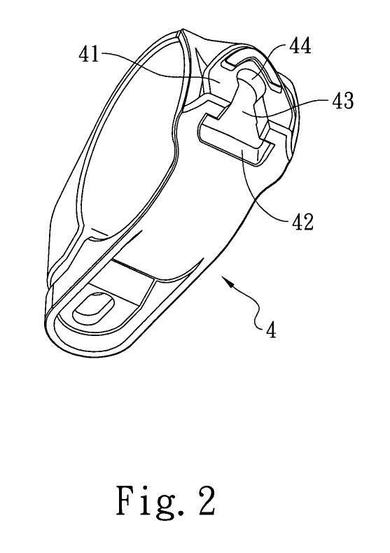

Referring to FIGS. 1 and 2, a lamp set for a bicycle 1 of an embodiment of the present invention is illustrated, wherein the lamp set for a bicycle comprises a lamp base 2, a connector 3, and an annular fastener 4.

The lamp base 2 is utilized for providing illumination, wherein the lamp base 2 includes a housing 21 with its both sides of the lower part being disposed with a sliding socket 22 respectively, and both sides of the upper part of the connector 3 corresponding to the sliding sockets 22 are disposed with a wing portion 31 respectively to allow the connector 3 to move in the lower part of the connector 3 while the wing portions 31 enter the sliding sockets 22; the annular fastener 4 is mounted around a bicycle frame and disposed with a connecting part 41 for removably connecting to the connector 3.

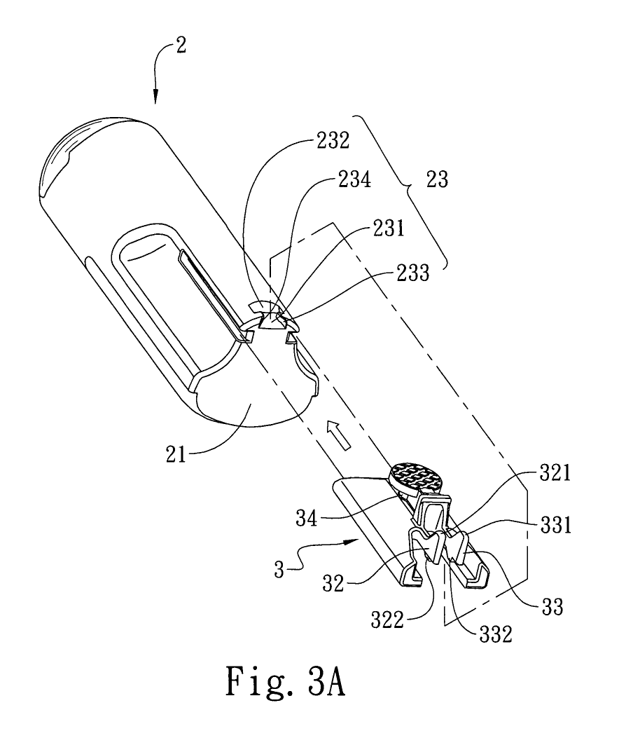

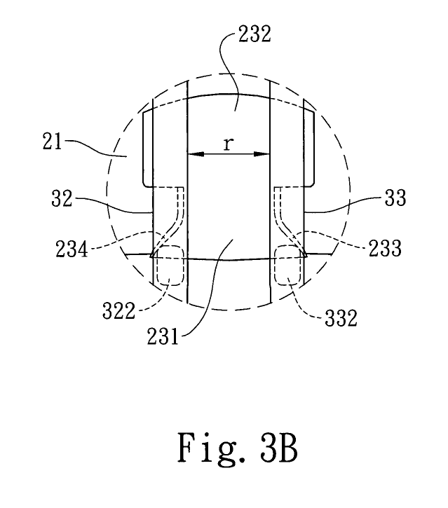

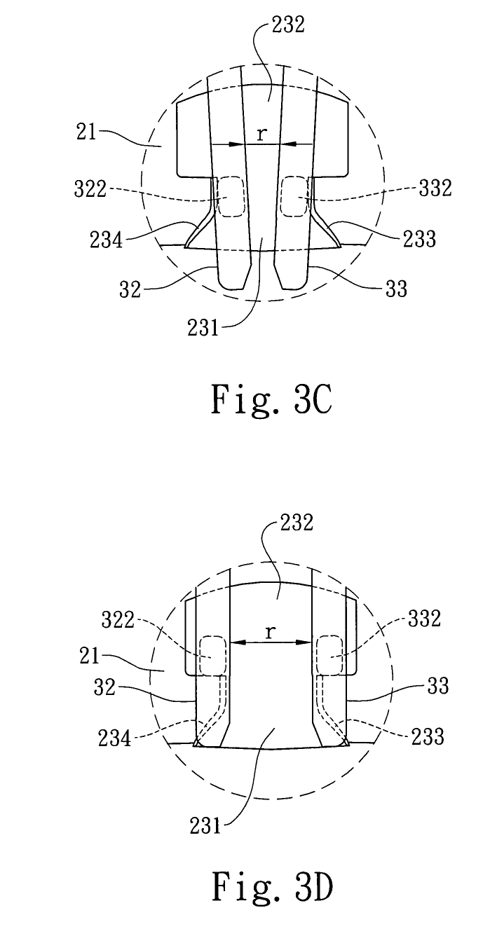

As shown in FIGS. 3A and 3B, the housing 21 is disposed with an engaging part 23 concaved inwardly at the lower part of the housing 21, and the engaging part 23 includes a first indentation 231 and a second indentation 232 which are mutually communicated and forming an inverted T-shaped configuration, wherein the engaging portion 23 is disposed with two slants 233 and 234 near the first indentation 231, and the length of the second indentation 232 is longer than the first indentation 231. The connector 3 is disposed with two engaging members 32 and 33 extending outwardly in the same direction from the connector 3, and the two engaging members 32 and 33 have a spacing r between the engaging members 32 and 33, and the ends of the engaging members 32 and 33 are disposed with pressing parts 321 and 331 for being pressed and squeezed by users to narrow the spacing between the engaging members 32 and 33. Further, both the engaging members 32 and 33 are disposed with an engaging block 322 and 332 respectively.

Referring to FIG. 2, the lower part of the connector 3 is disposed with a projection 34 for removably connecting to the connecting part 41 of the fastener 4, and the connecting part 41 is disposed with an indentation 42 forming a tapered passage 43 inwardly, and the end of the tapered passage 43 distends to form a locating space 44 for the projection 34 to enter along the tapered passage 43 and locate in the locating space 44.

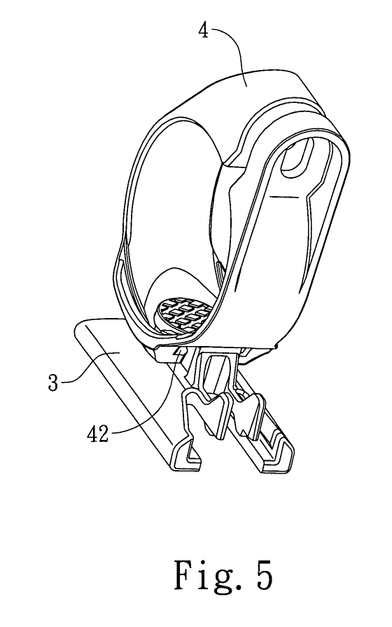

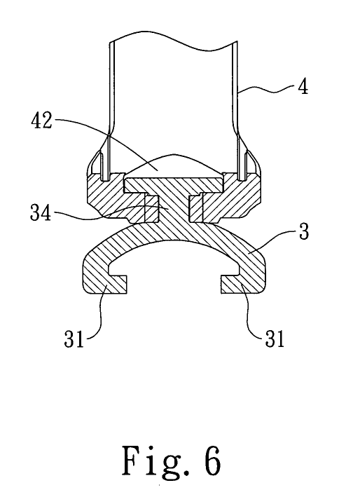

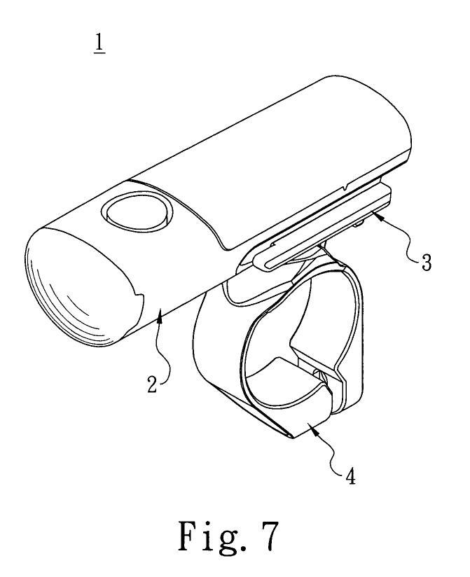

Therefore, as shown in FIGS. 1-7, firstly the sliding sockets 22 in both sides of the lower part of the housing 21 of the lamp base 2 are positioned opposite to wing portions 31 in both sides of the upper part of the connector 3, such that both the wing portions 31 can be pushed into the sliding sockets 22 to gradually combine the housing 21 and the connector 3 entirely; while the housing 21 is pushed to the first indentation 231 of engaging part 23 and contacts the engaging blocks 322 and 332 of the fasteners 32 and 33 of the connector 3, since the first indentation 231 of the engaging part 23 is disposed with two slants 233 and 234, the engaging blocks 322 and 332 can enter the first indentation 231 by the oppression of the moving housing 21 to compress the spacing r between the two engaging members 32 and 33 (as shown in FIG. 3C); after the engaging members 32 and 33 passed through the first indentation 231, the spacing r between the engaging members 32 and 33 is recovered to engage and locate the engaging blocks 322 and 332 in the second indentation 232 (as shown in FIG. 3D). When assembling the connector 3 and the fastener 4 to dispose the projection 34 in the lower part of the connector 3 into the indentation 42 of the connecting part 41, since the indentation 42 forms a tapered passage 43 inwardly, and the end of the tapered passage 43 distends to form a locating space 44, the projection 34 enters along the tapered passage 43 and locates in the locating space 44 firmly (as shown in FIGS. 5-7). As the assembling is finished, the annular fastener 4 is therefore mounted around a bicycle frame.

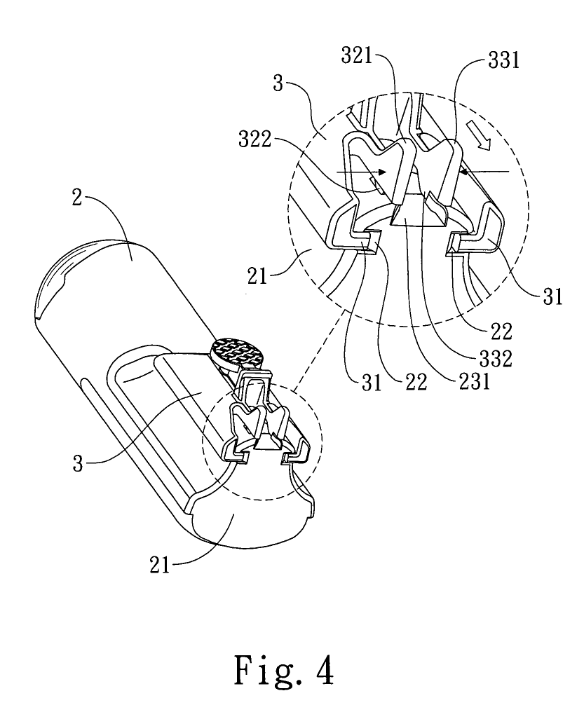

When the lamp base 2 is removed by users, as shown in FIG. 4, users just need to squeeze the pressing parts 321 and 331 at the ends of the engaging members 32 and 33 by fingers to compress the spacing between the engaging members 32 and 33 to the extent shorter than the length of the first indentation 231, the engaging blocks 322 and 332 of the engaging members 32 and 33 will depart from the second indentation 232 and the first indentation 231 sequentially to allow the lamp base 2 to detach from the engagement by the connector 3.

Therefore, the present invention has the following advantages:

1. The combination of the lamp base and the connector of the present invention mainly utilizes the engagement between engaging blocks of two engaging members and the first and second indentations of the engaging portion to make the two engaging members deformed by the squeezing of the first indentation, and enable the lamp base to be mounted on or removed from the connector without any fixing accessory, such that the present invention has advantages of simple structure and easy assembly to allow the mounted lamp base to securely connect to the connector and not to be drawn out immediately to reduce the risk of stealing.

2. The design of tight engagement between projections of the connector and the fastener in the present invention is different from conventional technique fixing the lamp by a screw, and once the connector of the present invention is fixed, the lamp base can be securely mounted on the connector and efficiently retain the position of lamp without situations such as screw loosing or deflection of lamp.

As stated in the above disclosed, the present invention can surely achieve its expected objects to provide a lamp set for a bicycle with simple structure and securely assembly.

It should be understood that different modifications and variations could be made from the disclosures of the present invention by the people familiar in the art without departing the spirit of the present invention.

What is claimed is:

1. A lamp set for a bicycle, comprising: a lamp base for providing illumination, the lamp base having a housing; a connector for removably engaging the housing; and an annular fastener for being mounted around a bicycle frame, the fastener being disposed with a connecting part for connecting to the connector; characterized in that:
the housing is disposed with an engaging part in its lower part, the engaging part including a first indentation and a second indentation which are mutually communicated, wherein the length of the second indentation is longer than the first indentation, and the connector is disposed with two engaging members extending outwardly in the same direction from the connector, wherein a spacing is formed between the engaging members and the engaging members are disposed with an engaging block respectively that the engaging blocks are capable of being squeezed by the first indentation to compress the spacing between the two engaging members while the engaging members enter the first indentation, and the spacing between the engaging members is recovered after the engaging members passed through the first indentation to engage and locate the engaging blocks in the second indentation; when the spacing between the engaging members is compressed and shorter than the length of the first indentation because of the squeezing of engaging members, the engaging blocks depart from the second indentation and the first indentation sequentially to allow the lamp base to detach from the engagement by the connector.

2. The lamp set for a bicycle according to claim 1, wherein the ends of the engaging members are disposed with pressing parts for being pressed and squeezed by users to narrow the spacing between the engaging members.

3. The lamp set for a bicycle according to claim 1, wherein the engaging portion is disposed with two slants near the first indentation.

4. The lamp set for a bicycle according to claim 1, wherein both sides of the lower part of the housing is disposed with a sliding socket respectively, and both sides of the upper part of the connector corresponding to the sliding socket is disposed with a wing portion respectively to allow the connector to move in the lower part of the connector while the wing portions enter the sliding sockets.

5. The lamp set for a bicycle according to claim 1, wherein the lower part of the connector is disposed with a projection for removably connecting to the connecting part of the fastener.

6. The lamp set for a bicycle according to claim 5, wherein the connecting part is disposed with an indentation forming a tapered passage inwardly, and the end of the tapered passage distends to form a locating space for the projection to enter along the tapered passage and locate in the locating space.

7. The lamp set for a bicycle according to claim 1, wherein the engaging portion is concaved inwardly at the lower part of the housing.

8. The lamp set for a bicycle according to claim 1, wherein the first indentation and the second indentation mutually which are communicated form an inverted T-shaped configuration.
